(19) United States
(12) Patent Application Publication
(10) Pub. No.: US 2002/0087327 A1
(43) Pub. Date: Jul. 4, 2002

(54) Computer-implemented HTML pattern parsing method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,681

(22) Filed: May 23, 2001

Related U.S. Application Data
(60) Provisional application No. 60/258,911, filed on Dec. 29, 2000.

(51) Int. Cl. G10L 21/00

(52) U.S. Cl. 704/270.1

(57) ABSTRACT

A computer-implemented method and system for speech recognition of a user speech input. A web page is retrieved from the Internet. Components of the web page and the components' type are identified in order to determine word usage data of the web page. The word usage data is used to recognize words of the user speech input.

### RELATED APPLICATION

This application claims priority to U.S. provisional application Serial No. 60/258,911 entitled “Voice Portal Management System and Method” filed Dec. 29, 2000. By this reference, the full disclosure, including the drawings, of U.S. provisional application Serial No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Internet web pages embody a great deal of information not only about the products or services that they are advertising, but also about the use of words that best conveys that information. For example, web pages that sell cellular telephones include the words and syntax that are most directed to the domain of cellular telephones. However, efforts to use such information are frustrated because of the varying and often inconsistent web page content programming (e.g., Hypertext Markup Language) used to create the web pages.

The present invention overcomes this disadvantage as well as others. In accordance with the teachings of the present invention, the present invention is a web page content verification system. For example, the present invention eliminates inconsistencies often found in the Hypertext Markup Language (HTML) of web sites and eliminates problems from files transmitted for processing and manipulation. The verification process encompasses parsing web page content into tokens and normalizing the codes. Content is broken down into basic components and then reassembled into consistent, manageable eXtensible Markup Language (XML) files. The present invention may include pattern processing to identify predefined web page programming components and to allow the assembly of those components into larger units for assembly on yet a larger scale. This process enables cleaner document coding by assigning irregular text to error categories, thus allowing the regular categories to maintain consistency.

The resulting XML file is then used to summarize the content of the web page. The summarized content identifies what are the preferred words and concepts for a particular domain. The words and concepts are used to recognize and process requests spoken by a user.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used by the present invention to parse and summarize Internet web pages;

FIG. 2 is a flow chart depicting exemplary web page processing and summarization performed by the present invention;

FIGS. 3 and 4 are block diagrams depicting the web page parsing performed by the present invention;

FIG. 5 is an exemplary web page that is parsed by the present invention;

FIG. 6 is a portion of XML code for an exemplary parsed web page;

FIG. 7 is a structure chart depicting the modules used by the pattern recognition and conceptualization unit; and

FIG. 8 is a flow diagram depicting pattern recognition and conceptualization performed by the present invention.

### DETAILED DESCRIPTION OF THE PREFERRED EMBODIMENT

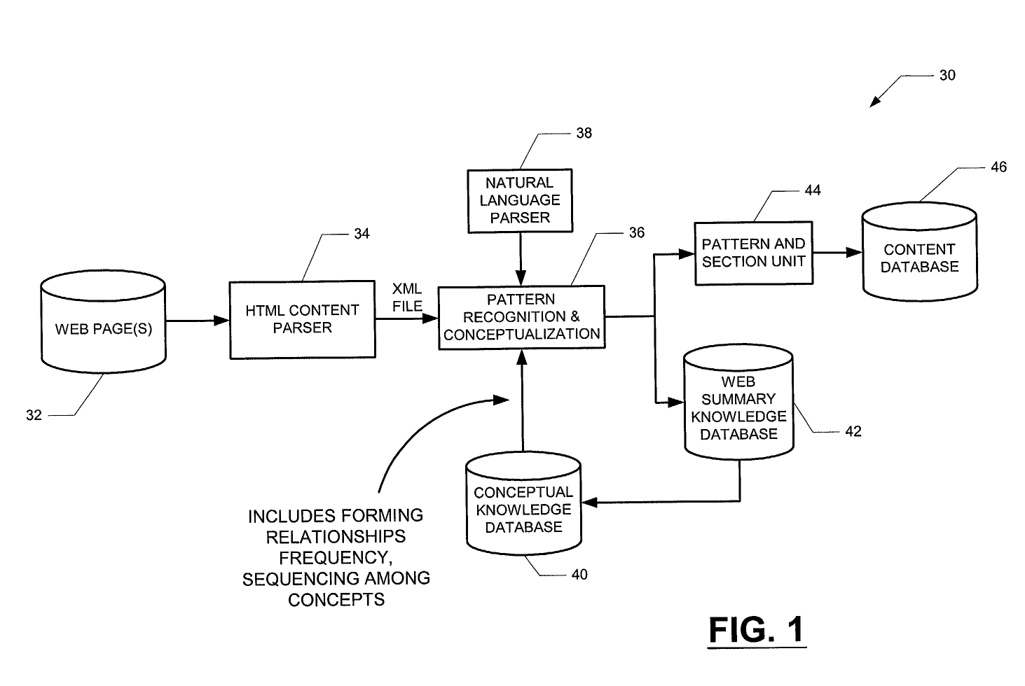

FIG. 1 depicts an Internet web page parsing and summarization system generally at 30. The parsing and summarization system 30 divides a web page's content into key components and then summarizes and conceptualizes the content. The summarization includes what concepts are on the web page and how those concepts interrelate. The summarization process also includes what words are used on the web page and with what frequency. This summarization process assists in identifying what words are most commonly found with what concepts. The topography of the web page is also captured so that any features on the web page such as hyperlinks, tables, or lists may help to summarize the web page. Such a summarized web page has many uses, such as use in speech recognition or for reading to a user who is on a mobile telephone.

Internet web pages 32 are obtained over the Internet network and are parsed, scanned for key words, and stored in a web summary knowledge database 42 that can be edited for content and used to recognize a user's spoken request. Use of the web summary knowledge database 42 to recognize speech is described in applicant's United States patent application entitled “Computer-Implemented Multi-Scanning Language Method And System” (identified by applicant's identifier 225133-600-007 and filed on May 23, 2001) which is hereby incorporated by reference (including any and all drawings).

First, a web page content parser 34 normalizes the web page document and converts it into an XML (eXtensible Markup Language) format, so that it may be analyzed at a later stage. The web page content parser 34 decomposes web pages into logical components, such as tables, lists, titles, text sections, paragraphs, links, etc. Tokenization is performed for pattern matching during the decomposition process.

After the components contained in the web page 32 have been identified, a categorization process is performed by a pattern recognition and conceptualization unit 36. The pattern recognition and conceptualization unit 36 reads the XML file and rearranges the information in a manner so that it may be further manipulated. Each XML tag is allocated to an object that will extract the data contained within and/or between the tags. Table and cell tags are treated in a manner such that a coordinate system later can be established when all the document information is gathered. Any textual information is stored in an object. This object contains the location of the text, the text itself and related links. This text object is beneficial because it enables a convenient repository that is readily accessible when transferring the data the object contains to a database. Once all the data is stored in objects, all the keywords and key-phrases are extracted and files that are used to assist in speech recognition and otherwise processing user requests. The text objects are sorted based on the coordinate system and an HTML (Hypertext Markup Language) file is created.

After the XML file has been read and the objects created, the pattern recognition and conceptualization unit 36 uses a natural language parser 38 to classify the contents of the logical units identified by the web page content parser 34. The natural language parser 38 scans the content objects for keywords and phrases and determines their parts of speech, such as identifying nouns, adjectives, and verbs. The natural language parser 38 accesses coding in a dictionary file that determines a “word class” or category for each word, and stores valid key words for the web summary knowledge database. The natural language parser 38 is described in applicant's United States patent application entitled “Natural English Language Search And Retrieval System And Method”, Ser. No. 09/732,190, filed Dec. 7, 2000 which is hereby incorporated by reference (including any and all drawings). At the present level each unit (i.e., a cleaved phrase produced by the natural language parser 38) is identified with a topic and a list of key concepts contained in it. For example, a paragraph from a web page 32 may be identified with a topic such as “Golf Techniques” and key concepts concerned with this paragraph such as “Putting”, etc. As another example, a table of links may be given a topic “Amazon Departments” and the major service categories are listed as key concepts (“Books”, “Electronics”, “Music”, “DVD”, etc.). The classification results, the frequency that terms appear on web pages, and the topology of the web pages are stored in the web summary knowledge database 42.

A pattern and section unit 44 further processes the results from the pattern recognition and conceptualization unit 36 to discern the contents of each component. For example, a paragraph may be recognized as “about US economy” and placed into the content database. The content database 46 serves as a knowledge-base. The information contained in the knowledge base is used in applications such as facilitating speech understanding. For example, if a component about the U.S. economy contains words such as “Dow Jones” and “Greenspan”, then this piece of knowledge may be used to set up a higher probability between these words in the context of U.S. economy.

The information stored in the web summary knowledge database 42 is used to build concept interrelationships that are stored in a conceptual knowledge database 40. These interrelationships are formed by scanning the web summary knowledge database 42 to obtain conceptual relationships between words and categories. The conceptual knowledge database 40 is used in pattern recognition and conceptualization processes to recognize concepts of a web page as well as frequency and sequencing of concepts.

Initially, the conceptual knowledge database 40 contains a set of conceptual relationships that are defined by the system developers. Through use of the present invention over time, the conceptual knowledge database 40 acquires many additional conceptual interrelationships. The conceptual knowledge database 40 provides a knowledge base of semantic relationships among words, thus providing a framework for understanding natural language. For example, the conceptual knowledge database 40 may contain an association (i.e., a mapping) between the concept “weather” and the concept “city.”

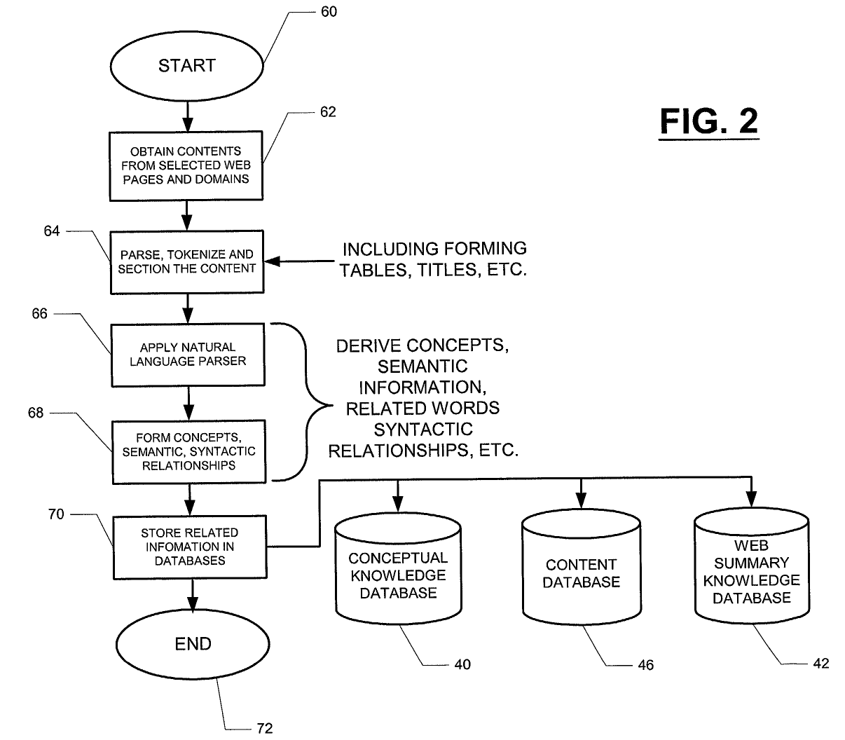

FIG. 2 depicts exemplary steps used by the present invention to process and summarize web pages. START block 60 indicates that at process block 62, the contents from selected web pages and domains are obtained. These web pages may be retrieved in a variety of ways, including simply retrieving those pages contained on a user-supplied list, or through more automated and possibly sophisticated means as retrieving those pages meeting or exceeding a specified confidence level and identified as a result of a search. Process block 64 parses, tokenizes, and divides the web page content into sections. The tokenized content is used to generate an XML file. Tokens identified during the tokenization process are used to create tags and/or sections of the XML file.

Process block 66 applies the natural language parser to the XML file, and process block 68 determines the concepts, semantic, and syntactic relationships of the web page content. Process block 70 stores the information in the web summary knowledge database 42, conceptual knowledge database 40, and content database 46.

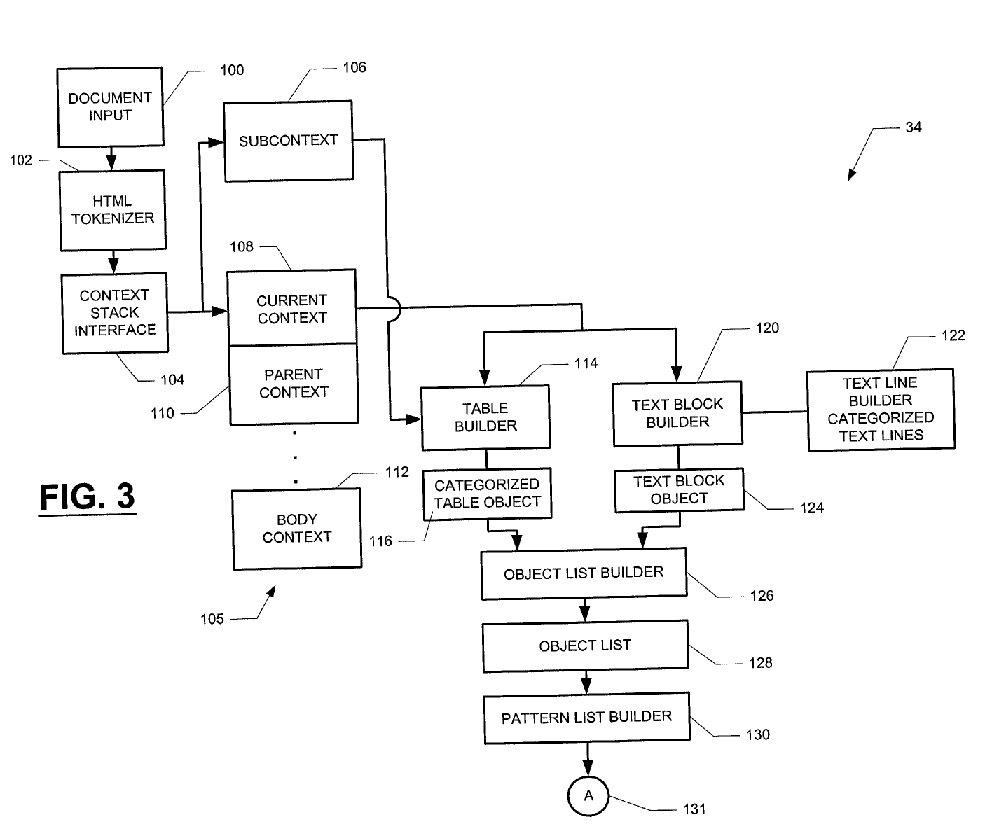

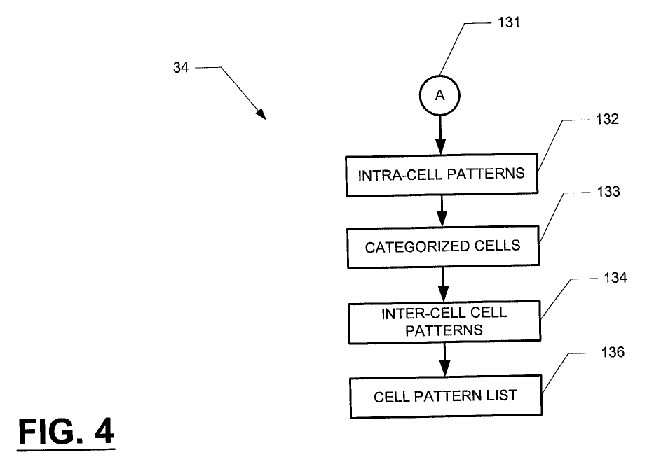

FIGS. 3 and 4 detail the web page content processing of the present invention. With respect to FIGS. 3 and 4, the web page content parser 34 reduces content of an input HTML document 100 to smaller units of data. Once parsed, the HTML tokenizer 102 identifies tokens within the parsed content. Tables contained within the HTML web page, usually identified by the HTML <TABLE>tag, are categorized as contexts. Cells within the current table context can themselves contain tables. When such a table within a table is encountered, the inner table is also categorized as a context. The context stack interface 104 keeps track of the current document table in the context stack and pushes a new context as the current context 108 onto the context stack 105 as contexts are fed through the HTML context parser 34. The result is that the context stack 105 contains a group of contexts. The first context pushed by the context stack interface 104 is the body context 112 which represents the entire web page being processed. Subsequent contexts pushed onto the context stack 105 represent successively finer-grained data representations. Contexts pushed onto the stack earlier are parent contexts of successive contexts and conversely contexts pushed onto the stack later are subcontexts of previously pushed contexts. Processing of all contexts is complete when the last context has been popped from the stack. Those skilled in the art will appreciate the operation of a stack and various possible implementations of a stack construct.

When processing contexts, the present invention will work with the subcontext 106 residing on the top of the context stack 105. The subcontext 106 will be processed by the table builder 114 which creates a conceptual table from the subcontext 106. The table builder 114 then creates a categorized table object 116 from the conceptual table. When processing the current context 108, depending upon the content of the current context 108, either the table builder 114 or the text block builder 120 may be invoked. If a block of text is encountered, the text block builder 120 creates a text block object 124 from the HTML text block. When building a text block, the text block builder 120 uses the services of the text line builder 122 to aggregate categorized text lines into text blocks.

The text block builder 120 keeps track of the state of various markup texts and any lists that are marked definitively as lists in HTML. The text block builder 120 monitors the markup texts being processed and any lists that are marked explicitly as lists in HTML. It resolves any inconsistencies in the code and uses text objects in the text block builder 120 to produce a list of text lines that have properly nested tags, no extra closing tags, and opening tags paired with their closing tags. The text block builder 120 creates and categorizes text lines from the parsed and tokenized HTML tags and page content. The text block builder 120 assembles the text lines into a text block object 124.

The object list builder 126 then accumulates text block objects and categorized table objects once they have been created. The object list builder 126 takes the accumulated objects and creates the object list 128. The pattern list builder 130 uses the object list 128 and other details such as cell sizes to identify and develop intra-cell patterns 132. The current context 108 is completely processed when a closing tag is detected, and the table is passed to its parent context 110 and is added to that parent context's object list. The table builder 114 recreates tables and sub-tables from the parsed HTML file, monitoring table description and table closing tags.

At each level of the hierarchy, categories exist for objects or patterns that do not fit the predicted forms. At the text line level, irrelevant content falls into the “Junk” category, and ambiguous content falls into the “Possible Junk” category, the default assignment for indeterminable content that does not match any other form. At the level of pattern matching, a Junk category contains irrelevant content, and a “Possible Header Pattern” contains ambiguous header-like content. On the level of cells, a “No₁₃ Type” category receives cells that have no assigned status, a “Junk” category receives unusable patterns, a “Possible Header” category contains single patterns that may be a header, and a “Hybrid” category exists for mixed-type cells. These categories remove material that does not conform to specifications and allow regularity and consistency in the other, predicted categories. This process results in a clean, reliable table that is then converted to an XML format that represents the table and text structure and content.

When the table end is signaled, the object list 128 is sent to the pattern list builder 130 where the cell list 136 is created. Each cell object is created and then matched with its associated objects according to its patterns. The pattern list builder 130 forms sub-lists of objects and sub-object blocks and categorizes them as patterns, which are collected into the pattern list for the cell. The pattern lists are categorized again into another set for pattern matching purposes. The cell also is categorized, producing a classification for the cell as a pattern comprised of other patterns. Cells are collected from the cell list and grouped according to matching patterns and categorized as types of cell patterns.

The cells are categorized at an intra-cell level at block 132. The categorizations resulting from the analysis are collected at block 133. Next, the cells are categorized at an inter-cell level at block 134. The categorizations resulting from the analysis are collected at block 136.

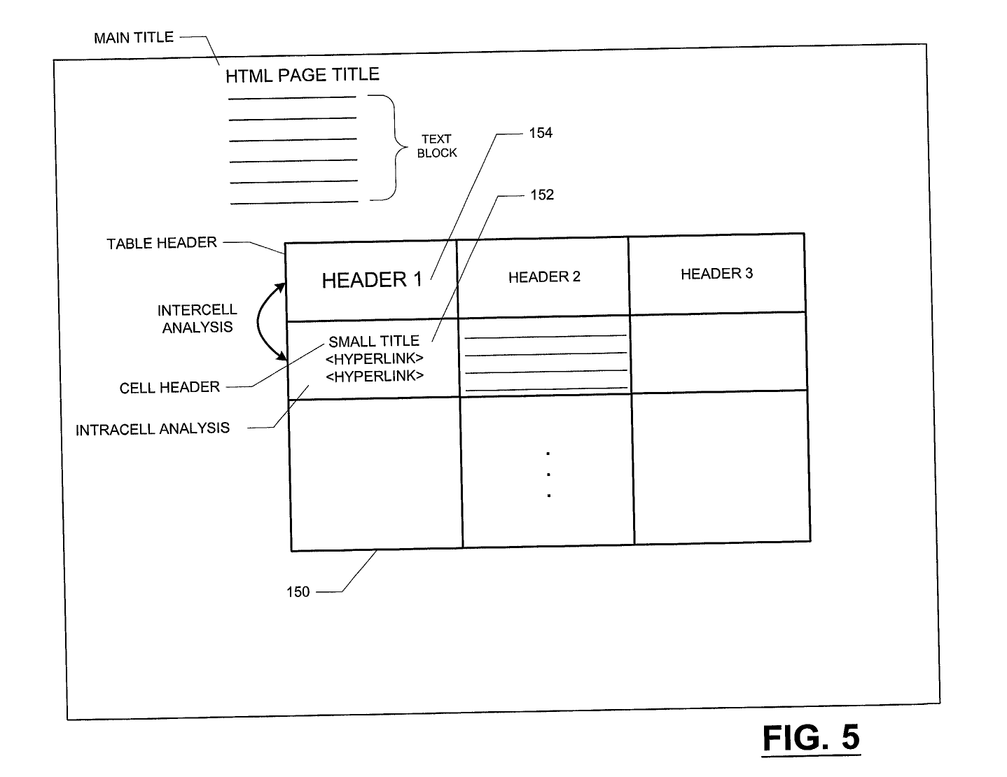

FIG. 5 depicts an example of intra-cell and inter-cell analysis. A primary table is shown at reference numeral 150. The primary table 150 includes a sub-table within cell 152. The sub-table 152 includes its own title and hyperlinks to other web pages. Intra-cell analysis of cell 152 associates the sub-table title with the sub-table 152 based upon the sub-table's title appearing in a more prominent font (e.g., larger size, bold, etc.) and appearing first in the cell 152. HTML presentation tags such as <FONT>, <B>, or <STRONG> can be used as identifiers to differentiate titles from other content. Inter-cell analysis examines one cell's characteristics in relation to those of another cell. For example, examination of the text characteristics of cell 152 and cell 154 reveals that the font characteristics of cell 154 are more prominent than those of cell 152 and the cell appears at the head of the table. Based upon the inter-cell analysis, the cell 154 is categorized as the primary table's header.

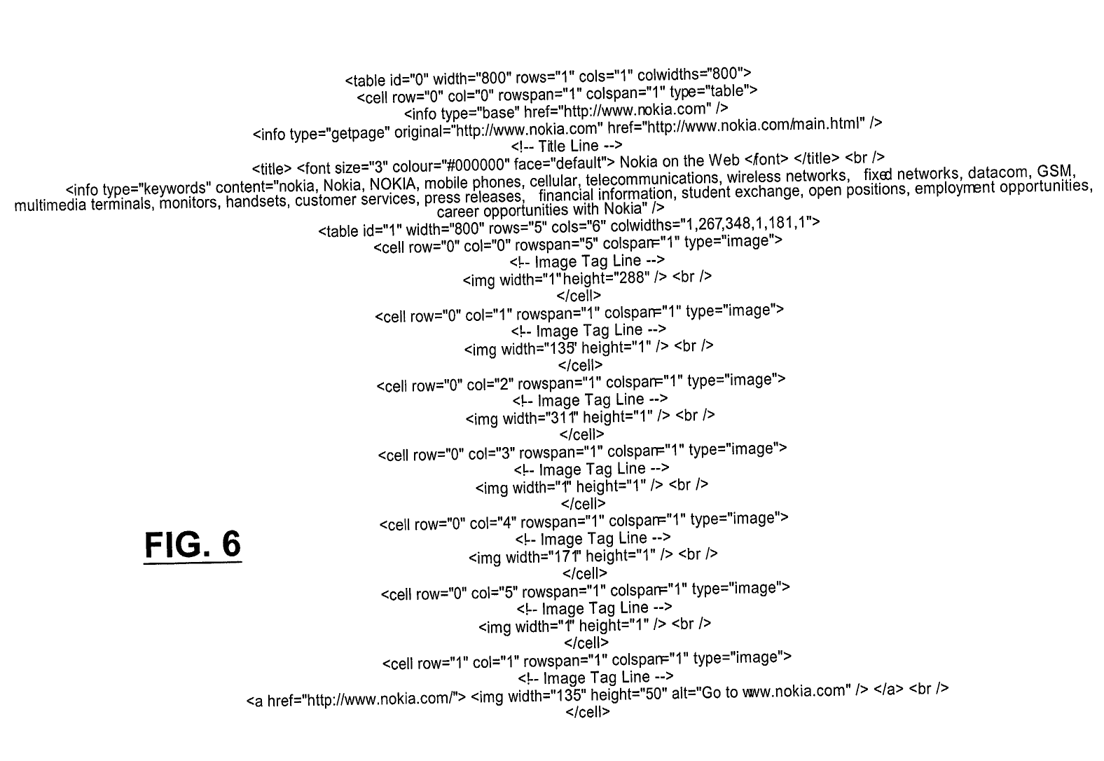

As an example of the HTML content parser 34, a Nokia web page is downloaded into the HTML parser where it is parsed and tokenized. A new context for the table is pushed onto the context stack 105 and becomes the current context 108. The table layout is sent to the table builder 114 and the markup text is sent to the text block builder 120. The text block builder 120 creates and categorizes text lines using a set of heuristics: titles, such as “Nokia 22” and “Nokia mPlatform Solution” are categorized as title text lines. Graphics are categorized as image tags. “Networks” is classed as a Category_Header, a short one-link line in bold. When all the text lines have been categorized they are stored as a text block object 124 and sent to the object list builder 126. Graphics are categorized as image patterns, a navigation bar is categorized as a navigation bar pattern, and the lists of options in the sidebar are categorized as explicit list patterns. Sub-tables from the table builder 114 are also accumulated. Items are also categorized as content, with lists and text, information for title patterns and tag line patterns, etc. The cell is applied to the patterns that are grouped together according to their matching characteristics, resulting in a classification for the cells, including the graphics, lists, and descriptions. These classifications result in an XML file being generated such as the one depicted in FIG. 6.

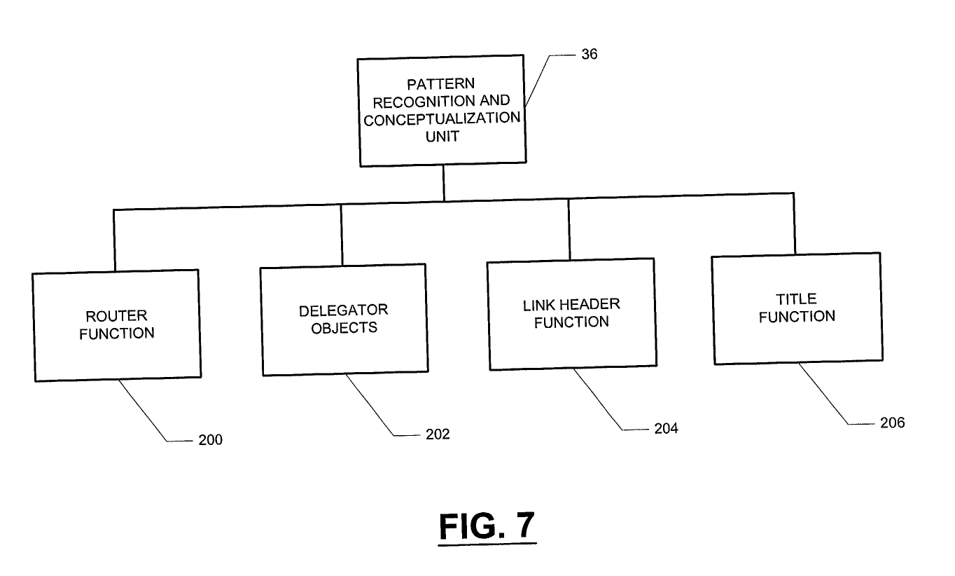

FIG. 7 depicts an exemplary software module structure for the pattern recognition and conceptualization unit 36. The pattern recognition and conceptualization unit 36 parses XML files and their stored content objects. Each XML file is first read and stored in a string that is passed to a router function 200. The router function 200 calls the appropriate delegator objects 202 for parsing the string and retrieving the information for the content objects. A link header function 204 collapses matching link headers taken from the same table cells into categories. A title function 206 scans the content objects and determines titles based on criteria such as table layout and font specifications. The natural language parser then scans the content objects for keywords and phrases and determines the parts of speech or “word class” to which the keywords belong, including nouns, adjectives, and verbs. If a word belongs to more than one category, its class is determined from its context in the user request. Keywords are written to the web summary knowledge database. During this process, HTML pages are created to ensure customization through a Common Gateway Interface (CGI). The process of converting XML files to HTML files may be accomplished by currently available techniques, such as those described in Beginning XML by David Hunter, WROX Press, ISBN 1-861003-4-12 at page 497.

For an example of the depiction contained in FIG. 7, the Nokia web site is downloaded from the Internet. After HTML to XML Verification has converted the content, delegator objects 202 are invoked by the router function 200 to parse and tokenize the file again. The delegator objects 202 store the tokens in memory. The link header function 204 reads through the file and detects “Mobile Phones,” “Multimedia Terminals,” “Networks,” and other headings that are linked to additional pages of information. The title function 204 finds “Nokia 22” and “Working with us,” as well as other titles. These textlines are grouped with other content that belongs in the same cell; for example, the “Nokia 22” title is associated with its text content and the accompanying image and caption. Finally, the natural language parser scans the content for key words and classifies them according to parts of speech. “Multimedia,” “Networks,” “WAP,” and “mPlatform,” among others, qualify as key words in user requests, classed as nouns. The content is stored in the database and the HTML/CGI component is created, from which irrelevant content is eliminated. Objects classed as images, for example, are not useful for the voice interface which can be used to voice summarized information to the user upon request. Other content that is not useful in responses to requests would also be eliminated.

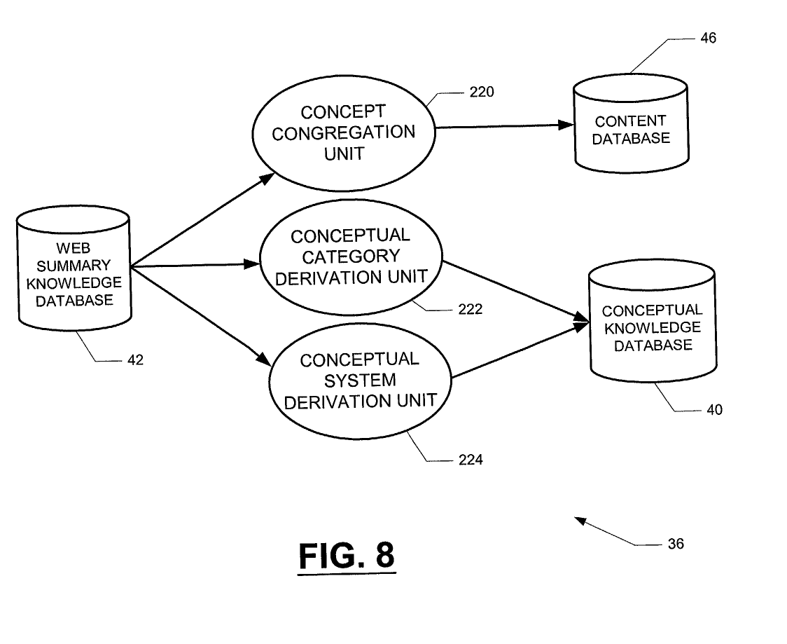

FIG. 8 depicts software modules that perform the pattern recognition and conceptualization 36 in accordance with the teachings of the present invention. The separated and classified contents of web pages are stored in the web summary knowledge database 42. With the data stored in the web summary knowledge database 42, conceptual information processing and knowledge acquisition are carried out by three units: the concept congregation unit 220, the conceptual category derivation unit 222 and conceptual system derivation unit 224. The conceptual congregation unit 220 assembles information concerning some important concepts together into concept clusters. A concept cluster aggregates pieces of web contents scattered all over the web concerning some central concepts. For example, a central concept like Israel will assemble a concept cluster with such information as “Israel-Arab Relations”, “Defense Systems of Israel”, etc. The congregated concept clusters are then stored in the conceptual content database 46. The content clusters are in a simpler form of organization, which can facilitate information search tasks, but is not sufficiently sophisticated for performing the function like reasoning with real-world knowledge. In order to perform such functions, the information further is organized, which is the task of the remaining two processing units 222 and 224. The conceptual category derivation unit 222 is a system to derive “conceptual structures” out of the concept cluster information. A conceptual structure is a logical unit, which specifies how a concept is related to other concepts through a set of attributes. For example, a country has a set of defining attributes that make a “Country” a country rather than something else. As an illustration, we give an exemplary list of attributes for a “Country” concept: [location, area, neighbor-countries, population, language, social-system, religion, income-per-capita, education, main-economy]. The differences between concept clusters and conceptual structures are (1) the latter is in a more compact form with only concept key-words linked by explicit attributes; (2) the latter is organized into a hierarchy with general concepts and specific concepts relationships explicitly specified. For example, a Ford is a specific Car and a Car is a specific Vehicle and a Vehicle is a specific Transportation-Machine, etc.

The conceptual system derivation unit 224 is a high level organizer of the conceptual structures produced by the conceptual category derivation unit 222. For example, the general-specific relation hierarchy is one of the organizing system produced by the conceptual system derivation unit 224. Besides this hierarchy, other organizing units are also produced by the conceptual system derivation unit 224. For example, if a number of industries are listed as concepts in the conceptual category derivation unit 222, the conceptual system derivation unit 224 may be able to derive such a system as “Industry Sectioning”, in which industries are divided into something like “Resources Industry,” “Service Industry,” “Manufacturing Industry,” “Information Technology Industry,” etc. In other words, conceptual systems are knowledge systems which organize conceptual categories in varying perspectives. With respect to the above example, the assigning may occur of such labels as “Resource Industry,” “Service Industry,” etc. to such concepts “Forestry: Resources,” “Coal-Mining: Resources,” “Fishing: Resources,” “Auto-Industry: Manufacturing,” “Catering: Service,” “Tourism: Service,” “Web-Search: IT,” etc.

The preferred embodiment described within this document is presented only to demonstrate an example of the invention. Additional and/or alternative embodiments of the invention will be apparent to one of ordinary skill in the art upon reading this disclosure.

It is claimed:

1. A computer-implemented method for speech recognition of a user speech input, comprising the steps of:
retrieving a web page from the Internet;
identifying components of the web page and the components' type;
using the identified components and their respective type to determine word usage data of the web page; and
using the word usage data to recognize words of the user speech input.
